(19) United States
(12) Patent Application Publication
(10) Pub. No.: US 2026/0320688 A1
(43) Pub. Date: Oct. 15, 2026

(54) ELECTRONIC TRADING SYSTEM WITH SIGNALS AND INSTRUCTIONS OPERABLE ON SUCH SIGNALS

(71) Applicant: TSX INC., Toronto (CA)

(72) Inventors: Rizwan AWAN, Mississauga (CA); Etienne CHARLEBOIS, Montreal (CA)

(21) Appl. No.: 19/485,587

(22) PCT Filed: May 16, 2024
(86) PCT No.: PCT/IB2024/054772

§ 371 Date: Nov. 18, 2025

(30) Foreign Application Priority Data
May 19, 2023 (CA) 3199966

(51) Int. Cl. G06Q 40/04

(52) U.S. Cl. CPC G06Q 40/046; G06Q 40/045

(57) ABSTRACT

An order message destined to a trading computing system includes an indication of a financial instrument, an indication of a signal, and an instruction that references the signal. The trading computing system monitors the signal and executes the instruction with reference to the signal to process an order for the financial instrument. The trading computing system may offer signals, so that order messages may select a signal from those offered.

### CROSS RELATED APPLICATIONS

The present disclosure claims priority to Canadian patent application 3199966 filed May 19, 2023, the contents of which are incorporated herein by reference.

### FIELD

The present disclosure relates to electronic trading systems.

### BACKGROUND

Electronic trading systems, which may also be known as electronic exchanges or venues, allow market participants to buy and sell financial instruments, such as stocks, commodities, funds, and similar.

### SUMMARY

According to an aspect of the present disclosure, a method includes a trading computing system receiving an order message from a market participant system via a computer network. The order message includes an indication of a financial instrument, an indication of a signal, and an instruction that references the signal. The method further includes the trading computing system monitoring the signal and executing the instruction with reference to the signal to process an order for the financial instrument.

According to another aspect of the present disclosure, a method includes a trading computing system offering a plurality of signals and receiving an order message. The order message identifies a selected signal of the plurality of signals. The order message contains an instruction that references the selected signal. The method further comprises the trading computing system processing an order for a financial instrument represented by the order message by executing the instruction with reference to the selected signal.

According to another aspect of the present disclosure, a trading computing system is configured to perform a method as described above.

According to another aspect of the present disclosure, a non-transitory machine-readable medium includes instructions that, when executed by a processor, perform a method as described above.

### BRIEF DESCRIPTION OF THE FIGURES

FIG. 1 is a diagram of an example system for processing an order message with reference to a signal and an instruction contained in the order message.

FIG. 2 is a flowchart of an example method for processing an order message with reference to a signal and an instruction contained in the order message.

FIG. 3 is a diagram of an example instruction-processing subsystem and matching engine.

FIG. 4 is a diagram of an example trading computing system with an example signal store.

### DETAILED DESCRIPTION

Trading participants have created quote detection mechanisms to predict when quotes may move in adverse directions impacting the profitability of trading at prices at which their orders are resting in an orderbook. Once the mechanism detects such a condition the participant will submit order amendment instructions to move the order to a safe price level or out of the market.

This disclosure describes techniques for a participant to provide the detection mechanism (or other triggers) to a market whereupon the detection mechanism predicting a condition, the market will automatically amend or otherwise process an order on behalf of the participant by, for example, increasing the value of the detection by executing the amendments or other processing faster than the participant could.

This also enables one participant's detection mechanism to be used by one or more other participants if there is an agreement between the two participants. The techniques discussed herein may thus automatically amend or otherwise process a participant's resting order based on detection by another participant's detection mechanism.

Participants may not be willing to share their signal generation methodology and choose instead to submit a signal trigger to the market whereupon the market receiving the trigger will amend or otherwise process orders that have subscribed to that signal in a specific manner.

The effectiveness of each prediction mechanism may be analyzed, and a unique prediction mechanism may be systematically created leveraging one or more participant prediction models. Multiple permutations of prediction mechanisms may be programmatically compared and back tested against past and current market data to determine effectiveness. Optimal detection mechanisms may be derived per defined security attributes which may exhibit distinct trading characteristics (e.g., stocks>$1, index constituents on and off a rebalance period, ETFs, security sectors, financial announcement dates, etc.).

Market participants have the ability to specify instructions to follow a specific signal or multiple signals and a predetermined order action is to be taken based on the signal.

A signal is a message that can include different types of factors. Some signals may be on-off switches (e.g., Boolean values) identifying the instrument is in a trading state or direction. Other signals may be in the form of prices or any numerical form factors, such as gradation indicator.

A signal may be sent to the trading platform and, following reception, the matching engine may process the order's instructions in a first-in, first-out (FIFO) manner, such as by processing a deteriorating order before an aggressive order. Other prioritization schemes may be additionally or alternatively applied.

Example instructions include re-pricing (e.g., a specific number of tick movement, depending on the signal there could be multiple re-price in any direction), pegging a price to a signal value, hide/unhide (e.g., convert to dark), hold outside of order book (temporarily), reinsert order, cancel, etc.

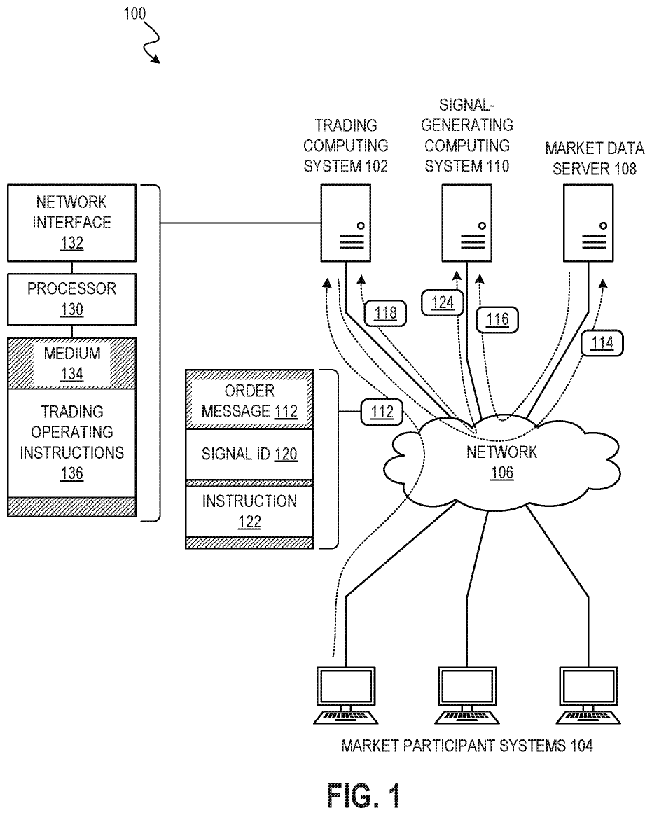

With reference to FIG. 1, a system 100 includes a trading computing system 102, a plurality of market participant systems 104, a computer network 106, a market data server 108, and a signal-generating computing system 110. The trading computing system 102, market participant systems 104, market data server 108, and the signal-generating computing system 110 are connected to the computer network 106.

The trading computing system 102 includes a special-purpose computer with a processor 130, network interface 132, and non-transitory machine-readable medium 134 to receive, match, and fill orders received from the market participant systems 104. Such orders may include new orders, modifications to existing orders, cancelations, etc. and may take the form of electronic order messages 112. The trading computing system 102 may facilitate the trading of a plurality of different financial instruments, such as stocks, funds, bonds, etc., under various symbols or identifiers.

The trading computing system 102 may generate trading data 124, such as trade price, trade volume, and trade time. Trading data 124 may further include order message data, such as order type (e.g., new, modification, cancelation, etc.), order side, order price, order volume, order time, order condition (e.g., limit or stop conditions), etc. Trading data 124 may be provided for various different financial instruments. The trading computing system 102 may generate trading data 124 in real time as trading occurs, and may output trading data in real time, at intervals, or according to a schedule.

Each market participant system 104 may include a general-purpose or special-purpose computer with a processor and non-transitory machine-readable medium to receive input data and provide output data related to trades to be carried out at the trading computing system 102. Each market participant system 104 is capable of generating an order message 112 and transmitting the order message 112 to the trading computing system 102.

The computer network 106 may include a local-area network (LAN), wide-area network (WAN), virtual private network (VPN), a mobile network, the internet, or a combination of such. The computer network 106 may be wired or wireless or may have both wired and wireless components.

A market data server 108 includes a special-purpose computer with a processor and non-transitory machine-readable medium to obtain trading and/or order data 114 from various trading computing systems, such as the system 102, and publish related market data 116 in human-or machine-intelligible formats. There may be any number of market data servers 108. The market data server 108 may be omitted in implementations that have another source of suitable data, such as trading data 124 provided by the trading computing system 102.

Market data 116 provided by a market data server 108 may include trade data, such as trade price, trade volume, and trade time; and order message data, such as order type (e.g., new, modification, cancelation, etc.), order side, order price, order volume, order time, order condition (e.g., limit or stop conditions), etc. Market data may be provided for various different financial instruments. The market data server 108 may publish the market data in real time, at intervals, or according to a schedule.

The signal-generating computing system 110, or signal source, may include a general-purpose or special-purpose computer with a processor, network interface, and non-transitory machine-readable medium. The signal-generating computing system 110 may receive trading data 124 from the trading computing system 102 and/or market data 116 from a market data server 108 or other source. The medium stores signal generation instructions that are executable by the processor to generate a signal 118 based on the trading data and/or market data 116 or on other data.

There may be multiple signal-generating computing systems 110, each generating and disseminating one or more signals 118. A signal-generating computing system 110 may be a computing system that is separate and independent of the trading computing system 102 and market data servers 108. A market data server 108 may include a signal-generating computing system 110. The trading computing system 102 may include a signal-generating computing system 110. A market participant system 104 may include a signal-generating computing system 110. Any suitable computing system may generate and disseminate a signal 118.

The trading computing system 102 may offer a plurality of signals 118 and may sell or offer subscriptions to the signals 118 to the operators of the market participant systems 104. That is, the trading computing system 102 may provide a signal store or marketplace. Such a signal store may offer signals 118 generated by the trading computing system 102, independent signal-generating computing systems 110, market participant systems 104, or other entities. That is, the trading computing system 102 may generate its own signals and may offer its own signals as well as signals generated by other entities.

Each signal 118 has a unique identifier so that a particular signal can be unambiguously referenced.

The trading computing system 102 receives order messages 112 for financial instruments. An order message 112 may be received from a market participant system 104 for a particular financial instrument. An order message 112 may be a traditional order message, or the order message 112 may be configured by the market participant system 104 to include a signal identifier 120 that identifies a selected signal 118 of interest and further to include a signal-referencing instruction 122 that references the selected signal 118.

The trading computing system 102 monitors the signal 118 referenced by the order message 112 and executes the instruction 122 with reference to the signal 118 to process an order for the financial instrument.

An order message 112 may reference any number of signals 118 and may include any number of instructions 112. Further, as mentioned, the trading computing system 102 supports conventional order messages and not every order message 112 need reference a signal 118 and include an instruction 122.

The trading computing system 102 includes a processor 130 that cooperates with a non-transitory machine-readable medium 134 to execute instructions 136, termed “trading operating instructions” to distinguish from signal-referencing instructions 122 contained within order messages 112.

The processor 130 may include a central processing unit (CPU), a microprocessor, a processing core, a field-programmable gate array (FPGA), an application-specific integrated circuit (ASIC), or a similar device capable of executing the instructions. The terms “a processor” and “the processor,” as used herein, mean one or more processors that collectively execute instructions. When multiple processors are used, one processor may execute some instructions and another processor may execute other, cooperating instructions.

The trading computing system 102 includes a non-transitory machine-readable medium 134 that may include an electronic, magnetic, optical, or other type of non-volatile physical storage device that encodes the trading operating instructions 136 that implement the functionality discussed herein. Examples of such storage devices include a non-transitory machine-readable medium such as a hard drive (HD), solid-state drive (SSD), read-only memory (ROM), electrically-erasable programmable read-only memory (EEPROM), or flash memory.

The trading computing system 102 includes a network interface 132 that includes hardware, such as a network adaptor, and software, such as a driver, to facilitate data communications via the computer network 106.

The trading operating instructions 136 may be directly executed, such as binary or machine code, and/or may include interpretable code, bytecode, source code, or similar instructions that may undergo additional processing to be executed. All of such examples may be considered executable instructions.

The trading operating instructions 136 receive and process order messages 112, monitor signals 118 referenced by order messages 112, and execute signal-referencing instructions 122 contained within order messages 112.

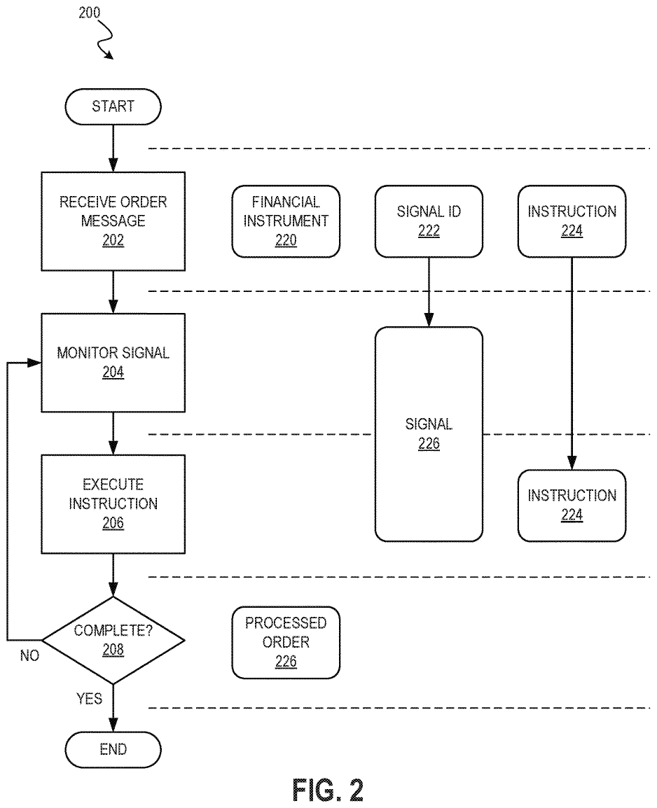

FIG. 2 shows a method 200. The method 200 may be implemented by processor-executable instructions, such as the trading operating instructions 136 discussed above.

At block 202, an order message is received. The order message may be transmitted by a market participant system to a trading computing system. The market participant system specifies certain data for the order message including an indication of a financial instrument 220 to buy or sell (e.g., a stock symbol or code). The market participant system may further specify in the order message an identifier 222 of a signal 226 and an instruction 224 associated with the signal 226. If the order message does not specify a signal identifier 222 and instruction 224, the order message is processed conventionally.

The market participant system may select the signal 226 from a plurality of signals offered by the trading computing system, which may originate at the trading computing system, an independent computing system (e.g., an analyst that generates a signal and provides a signal to the trading computing system), another market participant system that generates and shares signals, or another source. The signal may be generated based on market technical data, fundamental data, news, weather, etc. and the generation methodology may be proprietary or secret. The signal 226 may take the form of a Boolean value, a numerical value, a price, a non-price numerical value, a percentage, a ratio, or similar value. The signal 226 is not expected to be price data per se. Rather, the signal 226 is expected to be a computed or derived value that may be determined from price data. That said, the signal 226 could be price data if price data is useful as-is. The signal 226 may update periodically, regularly, at various intervals, in real time or near-real time, as triggered based on a change in underlying data, or according to other methodology.

The market participant system may select the instruction 224 from a set of instructions implemented by the trading computing system. A sequence of instructions 224 may be specified. An instruction 224 may specify a condition or logical test, such as equality (e.g., A=B) or inequality (e.g., A>B, A>=B, A<B, A<=B, A!=B, etc.). Instructions 226 may implement or resemble a programmatic script. Example instructions 226 are configured to cause the trading computing system to create an order, cancel an order, amend an order, move an order to another market, remove an ineligible order and reinsert it when it becomes eligible, or similar.

Example pseudocode of a signal identifier 222 and instructions 224 to conditionally place an order to buy a security with the symbol EXAMPLE based on a signal X, which may represent price stability for instance, is as follows:
Monitor signal X;
If signal>0.8 then create buy order for 3000 shares of EXAMPLE at $10.05 and halt;
Else if signal>0.5 then create buy order for 2000 shares of EXAMPLE at $10.00 and halt;

In this simple example, the instructions 224 may be executed periodically, continually, at intervals, etc. and the signal X may be monitored. Execution of the instructions 224 may be performed by a matching engine that continuously attempts to process orders. If the signal exceeds a value given (i.e., 0.8 or 0.5), then a respective buy order would be created. As can be seen from this simple example, the market participant is willing to purchase more shares at a higher price if that price is indicated by signal X to have greater stability. The meaning of signal X is unimportant to the method 200.

The above is a simple example for illustrative purposes. It is contemplated that a given set of one or more instructions 224 may reference one or more signals 226 and may be configured to operate on values such as price, quantity, time, order attribute, eligibility, etc. of one or more financial instruments.

The trading computing system may validate the instructions 224. Validation may include confirming that the instructions 224 are well-formed and without syntax errors and variable type errors, testing for deterministic behavior, confirming that numeric values provided are within acceptable ranges, and so on. Execution of the instructions 224 may be conditional on the instructions 224 being successfully validated. That is, an order containing invalid instructions may be refused and the market participant may be notified accordingly.

At block 204, the signal 226 specified in the order message is monitored and the value or state of the signal 226 that is specified with a signal ID 222 in the order is obtained. The value/state relevant to an order may be the most current (latest) value/state of the signal. Various orders and order processing methodologies may specify another relevant value/state for an order. Monitoring the signal may include the trading computing system assigning a listening agent to the signal. The signal 226 may be continuously monitored, even when no relevant order exists. The listening agent may provide the value of the signal to the instructions provided in the order message.

At block 206, the trading computing system executes the instruction 224 with reference to the signal 226. Execution of the instructions 224 and monitoring the signal 226 may be ongoing, as discussed above. An instruction 224 may specify a validity time or range or time, after which execution of the instructions 224 and monitoring of the signal 226 are halted. Additionally or alternatively, an instruction 224 may specify halting execution when another condition is met, such as immediately after an order is created (see example above).

At block 208, after execution of the instructions 224 completes, the order 228 for the financial instrument may be considered processed. Whether an order was created, amended, canceled, etc. depends on the behavior of the signal 226 and the configuration of the instructions 224. The market participant is notified as to the result of the processing. A notification indicating whether an order was created, amended, canceled, etc. and the particulars thereof may be automatically transmitted to the market participant system.

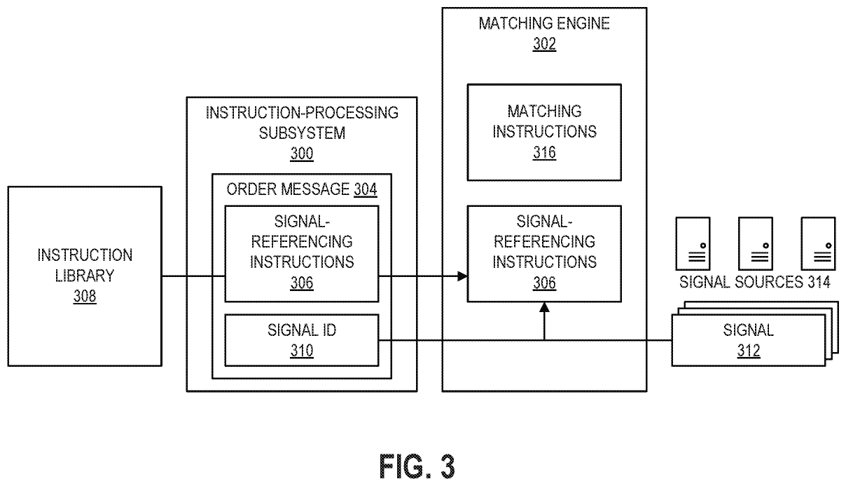

FIG. 3 shows an example instruction-processing subsystem 300 and matching engine 302.

An order message 304 may be configured with signal-referencing instructions 306 that are selected from a library 308 of supported instructions. Any suitable number and arrangement of instructions 306 may be provided.

The order message 304 may be configured with a signal identifier 310 that identifies a signal 312 to provide to the instructions 306. The signal 312 is selected from a plurality of signals provided by signal sources 314.

The instruction-processing subsystem 300 may receive the order message 304, validate the signal-referencing instructions 306, and pass the validated instructions 306 and signal identifier 310 to the matching engine 302. In various examples, the instruction-processing subsystem 300 may be implemented within the matching engine 302. In other examples, the instruction-processing subsystem 300 may be implemented outside the matching engine 302, as depicted.

The matching engine 302 may be configured with matching instructions 316 to match orders to form trades, as is conventional. The matching engine 302 may be configured to process the signal-referencing instructions 306 with reference to the signal 312. The matching engine 302 executes the instructions 306 and monitors the relevant signal 312, as part of the matching process provided by the matching instructions 316.

The matching engine 302 does not compute the signal 312. Rather, the signal 312 is computed by an external signal source 314, which may be part of the trading system to which the matching engine 302 belongs or which may be a separate and independent computing system. The matching engine 302 simply executes the signal-referencing instructions 306 with reference to the signal 312 as part of the process to generate orders and make trades.

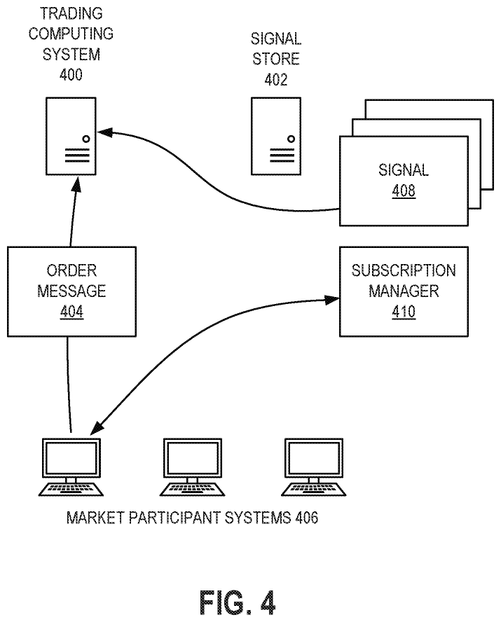

FIG. 4 shows an example trading computing system 400 with an example signal store 402.

The trading computing system 400 receives order messages 404 from market participant systems 406 and provides a matching engine to match orders to form trades. Various order messages may identify a signal 408 and provide instructions operable with the signal 408, as discussed above.

The signal store 402 provides a plurality of signals 408 that may be referenced by instructions contained in order messages 404. The signal store 402 may provide signals generated by the trading computing system 400 and/or external sources, such as an analyst computing system, market data server, and other signal sources. The signal store 402 is implemented with a computing system. The signal store 402 may be part of the trading computing system 400.

The signal store 402 may include a subscription manager 410 to manage subscriptions to signals 408 by the market participant systems 406. The subscription manager 410 may associate each market participant system 406 with subscribed signals 408. The subscription manager 410 may prevent access to a signal 408 that is not subscribed. An order message 404 that references an unsubscribed signal 408 may cause the order message 404 to fail validation and be rejected.

A subscription to a signal 410 may be periodic, such as daily, weekly, monthly, yearly, etc. A subscription may stipulate a fee payable to the source of the signal 408 and a fee due from the subscribing market participant 406. Signals 408 may have different fees set by the signal sources. Signals may be bundled. Additionally or alternatively, a signal 408 may have a “per use” fee, in that each order message 404 that references the signal results in a usage fee due to the signal source.

In view of the above, it should be apparent that a configurable sequence of instructions may be embedded in an order message and may reference a selectable signal, so that the instructions are executed with reference to the signal so as to carry out the intent of a market participant automatically and without further human intervention. A library of instructions and a repository of signals may be maintained for ready access by market participants.

It should be recognized that features and aspects of the various examples provided above can be combined into further examples that also fall within the scope of the present disclosure. In addition, the figures are not to scale and may have size and shape exaggerated for illustrative purposes.

1. A method comprising:
a trading computing system receiving an order message from a market participant system via a computer network, the order message including:
an indication of a financial instrument;
an indication of a signal; and
an instruction that references the signal;
the trading computing system monitoring the signal;
the trading computing system executing the instruction with reference to the signal to process an order for the financial instrument.

2. The method of claim 1, further comprising:
receiving the signal from a signal-generating computing system via the computer network.

3. The method of claim 2, wherein the signal-generating computing system is a computing system from which the order message is received.

4. The method of claim 2, wherein the signal-generating computing system is independent of a computing system from which the order message is received.

5. The method of claim 1, further comprising the trading computing system generating the signal.

6. The method of claim 5, further comprising the trading computing system generating the signal outside a matching engine of the trading computing system.

7. The method of claim 1, wherein the instruction is selected from a predetermined set of instructions offered by the trading computing system.

8. The method of claim 1, wherein the instruction is configurable with regard to price, quantity, time, order attribute, eligibility, or a combination of such.

9. The method of claim 1, further comprising:
the trading computing system validating the instruction;
wherein the trading computing system executing the instruction is conditional on the instruction being successfully validated.

10. The method of claim 1, wherein the order message includes a sequence of instructions that includes the instruction that references the signal.

11. The method of claim 1, further comprising:
the trading computing system collecting a first fee from a source of the order message; and
the trading computing system paying a second fee to a source of the signal.

12. The method of claim 1, further comprising:
the trading computing system managing a subscription of the market participant system to access the signal.

13. The method of claim 1, wherein the signal comprises:
a Boolean value;
a numerical value;
a price;
a non-price numerical value;
a percentage; or
a ratio.

14. The method of claim 1, wherein the instruction is operable to cause the trading computing system to process the order for the financial instrument by:
creating the order;
canceling the order;
amending the order;
moving the order to another market; or
removing the order when the order becomes ineligible and subsequently reinserting the order.

15. A trading computing system configured to perform the method of claim 1.

16. A non-transitory machine-readable medium comprising instructions that, when executed by a processor, perform the method of claim 1.

17. A method comprising:
a trading computing system offering a plurality of signals;
the trading computing system receiving an order message, the order message identifying a selected signal of the plurality of signals, the order message containing an instruction that references the selected signal; and
the trading computing system processing an order for a financial instrument represented by the order message by executing the instruction with reference to the selected signal.

18. A trading computing system configured to perform the method of claim 17.

19. A non-transitory machine-readable medium comprising instructions that, when executed by a processor, perform the method of claim 17.
